(19) United States
(12) Patent Application Publication
(10) Pub. No.: US 2014/0090516 A1
(43) Pub. Date: Apr. 3, 2014

(54) PEDAL FOR A BICYCLE

(71) Applicant: CHIEN KING INDUSTRIAL CO., LTD, Changhua Hsien (TW)

(72) Inventor: Tung-Min LIANG, Changhua Hsien (TW)

(73) Assignee: CHIEN KING INDUSTRIAL CO., LTD, Changhua Hsien (TW)

(21) Appl. No.: 13/632,844

(22) Filed: Oct. 1, 2012

(51) Int. Cl. B62M 3/08

(52) U.S. Cl. 74/594.4

(57) ABSTRACT

A pedal for a bicycle has two connecting boards and multiple fixing elements. The connecting boards are connected to each other and each connecting board has a shaft recess, a protruding segment, a recessed segment and multiple mounting recesses. The protruding segment and the recessed segment are respectively formed on an inner side of the connecting board beside the shaft recess. The protruding segment has an opening hole, an outer protruding tab, an inner protruding tab and multiple through holes. The recessed segment has an opening hole, an outer recess, an inner recess and multiple through holes. The fixing elements are connected to the connecting boards, and each fixing element has a fastener and a mounting head. The fastener is mounted in two through holes of the connecting boards and has two anti-slipping protrusions, a connecting head and an outer thread. The mounting head is screwed with the fastener.

### BACKGROUND OF THE INVENTION

1. Field of the Invention

The present invention relates to a pedal, and more particularly to a pedal for a bicycle. The pedal can be manufactured conveniently, can provide a preferred tightness and can reduce the cost of production.

2. Description of Related Art

Bicycles have become more and more popular in recent years. A bicycle virtually causes no environmental pollution, so the benefits are obvious to a world facing serious contamination. Therefore, various kinds of bicycles are developed and the components of the bicycle change quickly.

A conventional pedal for a bicycle is composed by two connecting boards. The connecting boards are connected to each other, and one of the connecting boards has multiple connecting recesses and the other connecting board has multiple connecting tabs. The connecting recesses and the connecting tabs of the connecting boards are respectively connected to each other to form the conventional pedal. However, the connecting boards of the conventional pedal are manufactured by two different molds and the conventional pedal needs to form multiple anti-slipping protrusions on the outer surfaces of the connecting boards to provide an anti-slipping effect to the user, and this will increase the cost and the complexity of production.

Therefore, the present invention provides a pedal for a bicycle to mitigate or obviate the aforementioned problems.

### SUMMARY OF THE INVENTION

The main objective of the present invention is to provide a pedal for a bicycle, the pedal can be manufactured conveniently, can provide a preferred tightness and can reduce the cost of production.

The pedal for a bicycle in accordance with the present invention has two connecting boards and multiple fixing elements. The connecting boards are connected to each other and each connecting board has a shaft recess, a protruding segment, a recessed segment and multiple mounting recesses. The protruding segment and the recessed segment are respectively formed on an inner side of the connecting board beside the shaft recess. The protruding segment has an opening hole, an outer protruding tab, an inner protruding tab and multiple through holes. The recessed segment has an opening hole, an outer recess, an inner recess and multiple through holes. The fixing elements are connected to the connecting boards, and each fixing element has a fastener and a mounting head. The fastener is mounted in two through holes of the connecting boards and has two anti-slipping protrusions, a connecting head and an outer thread. The mounting head is screwed with the fastener.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pedal for a bicycle in accordance with the present invention;

FIG. 2 is an exploded perspective view of the pedal for a bicycle in FIG. 1;

FIG. 3 is a side view of the pedal for a bicycle in FIG. 1;

FIG. 4 is a cross sectional side view of the pedal for a bicycle in FIG. 1; and

FIG. 5 is another cross sectional side view of the pedal for a bicycle in FIG. 1.

### DETAILED DESCRIPTION OF THE PREFERRED EMBODIMENT

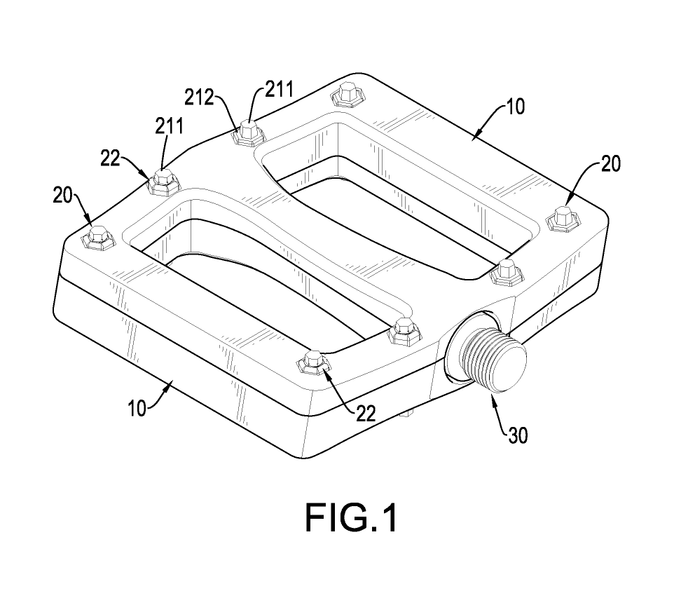

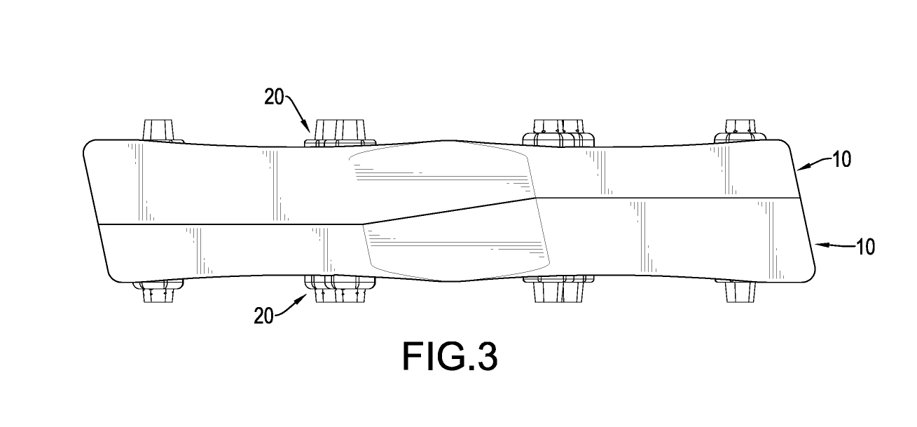

With reference to FIGS. 1 to 3, a pedal for a bicycle in accordance with the present invention comprises two connecting boards 10, multiple fixing elements 20 and a chain wheel shaft 30.

The connecting boards 10 may be a first connecting board 10 and a second connecting board 20, are connected to each other and each connecting board 10 has an inner side, an outer side, a middle, a shaft recess 11, a protruding segment 12, a recessed segment 13 and multiple mounting recesses 14. The shaft recess 11 is formed in the inner side of the connecting board 10 at the middle of the connecting board 10 and has two ends.

The protruding segment 12 is formed on the inner side of the connecting board 10 beside the shaft recess 11 and has an outer periphery, an opening hole 121, an outer protruding tab 122, an inner protruding tab 123 and multiple through holes 124. The opening hole 121 may be quadrate, is formed through the inner side and the outer side of the connecting board 10 beside the shaft recess 11 and has a shape. The outer protruding tab 122 is formed on and protrudes from the inner side of the connecting board 10 around the periphery of the protruding segment 12, extends to the ends of the shaft recess 11 and has a shape. Preferably, the outer protruding tab 122 aslant extends to one of the ends of the shaft recess 11.

The inner protruding tab 123 is formed on and protrudes from the inner side of the connecting board 10 around the opening hole 121 and has a shape. The through holes 124 may be threaded and are formed through the inner side and the outer side of the connecting board 10 at intervals between the protruding tabs 122, 123. In addition, the protruding segment 12 has multiple slots 125 formed in the inner side of the connecting board 10 between the through holes 124 to reduce the weight and material of the connecting board 10.

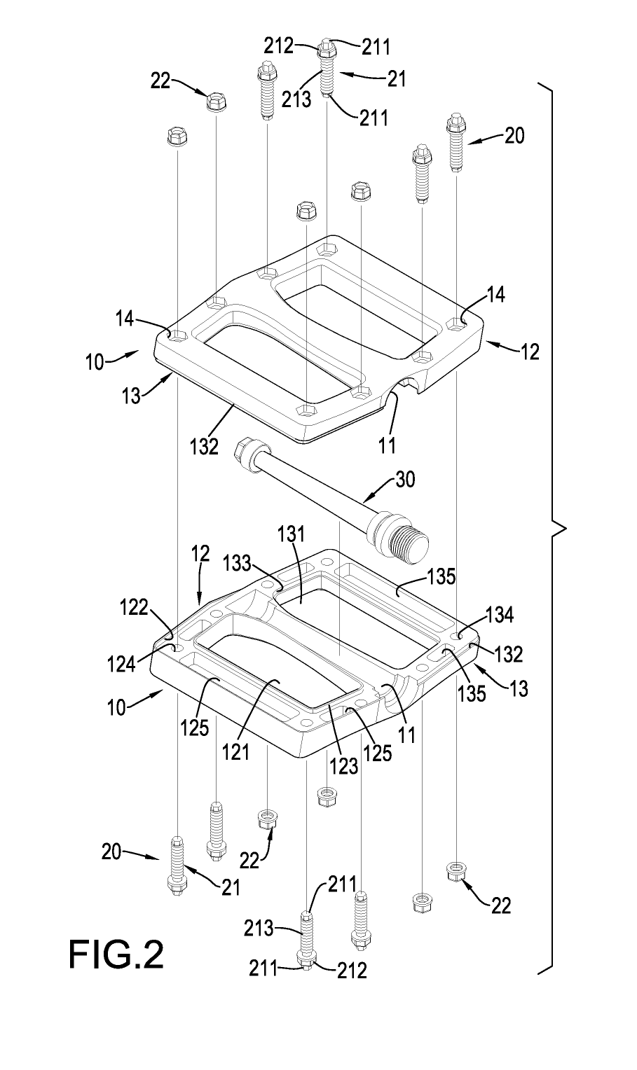

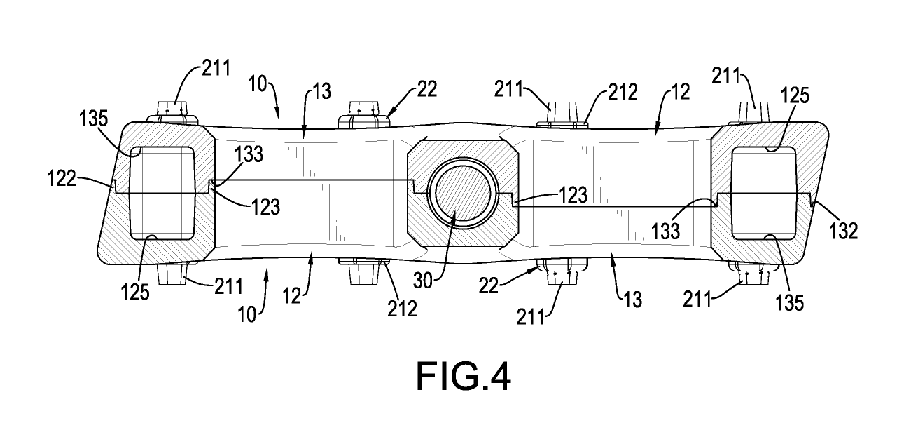

With reference to FIGS. 2 and 4, the recessed segment 13 is formed in the inner side of the connecting board 10 beside the shaft recess 11 opposite to the protruding segment 12 and has an outer periphery, an opening hole 131, an outer recess 132, an inner recess 133 and multiple through holes 134. The opening hole 131 may be quadrate, is formed through the inner side and the outer side of the connecting board 10 beside the shaft recess 11 opposite to the opening hole 121 of the protruding segment 12 and has a shape corresponding to the opening hole 121 of the protruding segment 12. The outer recess 132 is formed in the inner side of the connecting board 10 around the periphery of the recessed segment 13, extends to the ends of the shaft recess 11 and has a shape corresponding to the shape of the outer protruding tab 122. Preferably, the outer recess 132 aslant extends to the end of the shaft recess 11 to which the outer protruding tab 122 aslant extends.

The inner recess 133 is formed in the inner side of the connecting board 10 around the opening hole 131 and has a shape corresponding to the shape of the inner protruding tab 123. The through holes 134 may be threaded, are formed through the inner side and the outer side of the connecting board 10 at intervals between the outer recess 132 and the inner recess 133, and are corresponding to the through holes 124 of the protruding segment 12. In addition, the recessed segment 13 has multiple slots 135 formed in the inner side of the connecting board 10 between the through holes 134 to reduce the weight and material of the connecting board 10.

The mounting recesses 14 may be hexangular, are formed in the outer side of the connecting board 10 and respectively communicate with the through holes 124, 134 of the protruding segments 12 and the recessed segment 13.

The fixing elements 20 are connected to the connecting boards 10, and each fixing element 20 has a fastener 21 and a mounting head 22. The fastener 21 is mounted in one of the through holes 134 of the first connecting board 10 and a corresponding through hole 124 of the second connecting board 10 that aligns with the through hole 134 of the first connecting board 10, and has a top end, a bottom end, an external surface, two anti-slipping protrusions 211, a connecting head 212 and an outer thread 213.

The anti-slipping protrusions 211 are respectively and axially formed on and protrude from the top end and the bottom end of the fastener 21 and extend out of the outer sides of the connecting boards 10 via the corresponding through holes 124, 134 and two of the mounting recesses 14 of the connecting boards that communicate with the corresponding through holes 124, 134 to provide an anti-slipping effect to the connecting boards 10. The connecting head 212 is formed on and protrudes from the external surface of the fastener 21, is formed with one of the anti-slipping protrusions 211 and is mounted in the corresponding mounting recess 14 of the first connecting board 10. The outer thread 213 is formed around the external surface of the fastener 21 between the connecting head 212 and the anti-slipping protrusion 211 that is opposite to the connecting head 212. Preferably, the outer thread 213 of the fastener 21 is screwed with the corresponding through holes 124, 134 of the connecting boards 10.

The mounting head 22 is screwed with the outer thread 213 of the fastener 21 in the corresponding mounting recess 14 of the second connecting board 10 from the anti-slipping protrusion 211 that is opposite to the connecting head 212 to connect the connecting boards 10 with each other.

The chain wheel shaft 30 is mounted in the shaft recesses 11 of the connecting boards 10 and has a connecting end extending out of the connecting boards 10 to connect with a chain wheel of a bicycle.

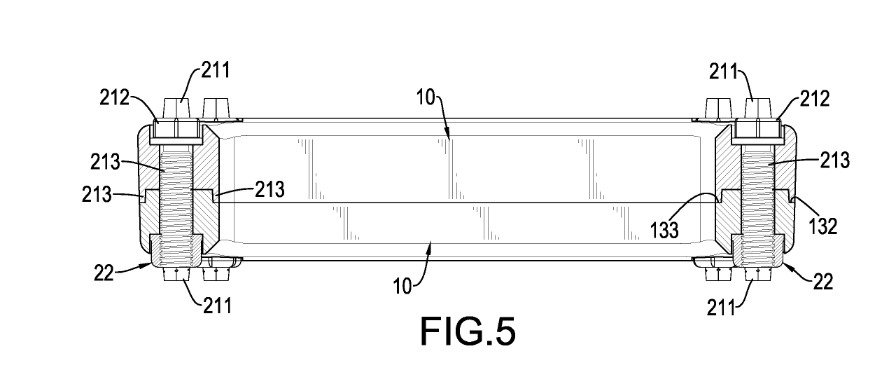

With reference to FIGS. 2, 4 and 5, the connecting boards 10 can be manufactured by a single mold and this can reduce the time, the cost and the complexity of production. When assembling the connecting boards 10, the fixing elements 20 and the chain wheel shaft 30 to form the pedal in accordance with the present invention, the inner sides of the connecting boards 10 face to each other and the chain wheel shaft 30 is mounted in the shaft recesses 11 between the connecting boards 10. Then, the protruding tabs 122, 123 and the recesses 132, 133 of the first connecting board 10 are respectively connected to the recesses 132, 133 and the protruding tabs 122, 123 of the second connecting board 10 to provide a preferred tightness to the pedal and a positioning effect to enable the through holes 124, 134 of the first connecting board 10 to respectively align with the through holes 134, 124 of the second connecting board 10.

When the through holes 124, 134 of the first connecting board 10 align with the through holes 134, 124 of the second connecting board 10, the fasteners 21 of the fixing elements 20 are respectively mounted in the through holes 124, 134 of the connecting boards 10 to enable the anti-slipping protrusions 211 of the fasteners 21 to extend out of the outer sides of the connecting boards 10 via the mounting recesses 14 to provide an anti-slipping effect to the connecting boards 10 of the pedal. Then, the mounting heads 22 are securely screwed with the outer threads 213 of the fasteners 21 from the anti-slipping protrusions 211 that are opposite to the connecting head 212 to connect the chain wheel shaft 30 securely with the connecting boards 10 to form the pedal for a bicycle in accordance with the present invention.

According to the above-mentioned features, the pedal for a bicycle in accordance with the present invention only needs one mold to manufacture the connecting boards 10 and this can reduce the time, the cost and the complexity of production. In addition, the protruding tabs 122, 123 and the recesses 132, 133 of the first connecting board 10 are respectively connected to the recesses 132, 133 and the protruding tabs 122, 123 of the second connecting board 10, and this can provide a positioning effect to the connecting boards 10 when assembling the connecting boards 10 and also can provide a preferred tightness to the pedal to prevent water from flowing into the inner sides of the connecting boards 10. Furthermore, the fixing elements 20 are used to connect the chain wheel shaft 30 securely with the connecting boards 10 and also are used to provide an anti-slipping effect to the connecting boards 10 without forming multiple anti-slipping protrusions on the outer sides of the connecting boards 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pedal for a bicycle having:
two connecting boards connected to each other, being a first connecting board and a second connecting board, and each connecting board having:
an inner side;
an outer side;
a middle;
a shaft recess formed in the inner side of the connecting board at the middle of the connecting board and having two ends;
a protruding segment formed on the inner side of the connecting board beside the shaft recess and having:
an outer periphery;
an opening hole formed through the inner side and the outer side of the connecting board beside the shaft recess and having a shape;
an outer protruding tab formed on and protruding from the inner side of the connecting board around the periphery of the protruding segment, extending to the ends of the shaft recess and having a shape;
an inner protruding tab formed on and protruding from the inner side of the connecting board around the opening hole of the protruding segment and having a shape; and
multiple through holes formed through the inner side and the outer side of the connecting board at intervals between the protruding tabs;
a recessed segment formed in the inner side of the connecting board beside the shaft recess opposite to the protruding segment and having:
an outer periphery;
an opening hole formed through the inner side and the outer side of the connecting board beside the shaft recess opposite to the opening hole of the protruding segment and having a shape corresponding to the opening hole of the protruding segment;
an outer recess formed in the inner side of the connecting board around the periphery of the recessed segment, extending to the ends of the shaft recess and having a shape corresponding to the shape of the outer protruding tab of the protruding segment;
an inner recess formed in the inner side of the connecting board around the opening hole of the recessed segment and having a shape corresponding to the shape of the inner protruding tab of the protruding segment; and
multiple through holes formed through the inner side and the outer side of the connecting board at intervals between the outer recess and the inner recess and corresponding to the through holes of the protruding segment; and
multiple mounting recesses formed in the outer side of the connecting board and respectively communicating with the through holes of the protruding segments and the recessed segment of the connecting board; and
multiple fixing elements connected to the connecting boards, and each fixing element having:
a fastener mounted in one of the through holes of the first connecting board and a corresponding through hole of the second connecting board that aligns with the through hole of the first connecting board and having:
a top end;
a bottom end;
an external surface;
two anti-slipping protrusions respectively and axially formed on and protruding from the top end and the bottom end of the fastener and extending out of the outer sides of the connecting boards via the corresponding through holes of the connecting boards and two of the mounting recesses of the connecting boards that communicate with the corresponding through holes of the connecting boards;
a connecting head formed on and protruding from the external surface of the fastener, formed with one of the anti-slipping protrusions and mounted in the corresponding mounting recess of the first connecting board that communicates with the through holes of the connecting boards; and
an outer thread formed around the external surface of the fastener between the connecting head and the anti-slipping protrusion that is opposite to the connecting head; and
a mounting head screwed with the outer thread of the fastener in the corresponding mounting recess of the second connecting board from the anti-slipping protrusion that is opposite to the connecting head to connect the connecting boards with each other.

2. The pedal for a bicycle as claimed in claim 1, wherein the pedal has a chain wheel shaft mounted in the shaft recesses of the connecting boards and having a connecting end extending out of the connecting boards.

3. The pedal for a bicycle as claimed in claim 1, wherein
the outer protruding tab of each one of the connecting boards aslant extends to one of the ends of the shaft recess; and
the outer recess of each one of the connecting boards aslant extends to the end of the shaft recess to which the outer protruding tab aslant extends.

4. The pedal for a bicycle as claimed in claim 2, wherein
the outer protruding tab of each one of the connecting boards aslant extends to one of the ends of the shaft recess; and
the outer recess of each one of the connecting boards aslant extends to the end of the shaft recess to which the outer protruding tab aslant extends.

5. The pedal for a bicycle as claimed in claim 3, wherein
each one of the through holes of the protruding segment and the recessed segment of each one of the connecting boards are threaded; and
the outer thread of the fastener of each one of the fixing elements is screwed with the corresponding through holes of the connecting boards.

6. The pedal for a bicycle as claimed in claim 4, wherein
each one of the through holes of the protruding segment and the recessed segment of each one of the connecting boards are threaded; and
the outer thread of the fastener of each one of the fixing elements is screwed with the corresponding through holes of the connecting boards.

7. The pedal for a bicycle as claimed in claim 5, wherein
the protruding segment of each one of the connecting boards has multiple slots formed in the inner side of the connecting board between the through holes of the protruding segment; and
the recessed segment of each one of the connecting boards has multiple slots formed in the inner side of the connecting board between the through holes of the recessed segment.

8. The pedal for a bicycle as claimed in claim 6, wherein
the protruding segment of each one of the connecting boards has multiple slots formed in the inner side of the connecting board between the through holes of the protruding segment; and
the recessed segment of each one of the connecting boards has multiple slots formed in the inner side of the connecting board between the through holes of the recessed segment.

9. The pedal for a bicycle as claimed in claim 7, wherein each mounting recess of each one of the connecting boards is hexangular.

10. The pedal for a bicycle as claimed in claim 8, wherein each mounting recess of each one of the connecting boards is hexangular.

11. The pedal for a bicycle as claimed in claim 1, wherein
each one of the through holes of the protruding segment and the recessed segment of each one of the connecting boards are threaded; and
the outer thread of the fastener of each one of the fixing elements is screwed with the corresponding through holes of the connecting boards.

12. The pedal for a bicycle as claimed in claim 1, wherein
the protruding segment of each one of the connecting boards has multiple slots formed in the inner side of the connecting board between the through holes of the protruding segment; and
the recessed segment of each one of the connecting boards has multiple slots formed in the inner side of the connecting board between the through holes of the recessed segment.

13. The pedal for a bicycle as claimed in claim 1, wherein each mounting recess of each one of the connecting boards is hexangular.
